(19) United States
(12) Patent Application Publication
(10) Pub. No.: US 2024/0116344 A1
(43) Pub. Date: Apr. 11, 2024

(54) TRUCK BUCKET COVERS, METHOD OF USE, AND METHOD OF MANUFACTURE

(71) Applicant: Adam J Kriz, Grain Valley, MO (US)

(72) Inventor: Adam J Kriz, Grain Valley, MO (US)

(21) Appl. No.: 18/378,406

(22) Filed: Oct. 10, 2023

Related U.S. Application Data
(60) Provisional application No. 63/414,763, filed on Oct. 10, 2022.

(51) Int. Cl. B60J 11/06

(52) U.S. Cl. CPC B60J 11/06

(57) ABSTRACT

A bucket cover formed from one piece of 40 oz vinyl material with fiberglass supports. These supports are held in place using a strip of vinyl that is permanently bonded in place, thereby avoiding the need for stitches and preventing a weak spot for leaks to accumulate. The fiberglass supports hold the cover up and away from the bucket, preventing sagging and eliminating water retention on the exterior of the cover. A gloss finish may be placed on the vinyl to improve resilience to sun and weather and to provide an easier surface to clean. The straps of the present invention are made of polyester which tends to hold up against UV rays and moisture better than polypropylene straps. The bucket cover can be constructed to fits buckets of all shapes and sizes.

### CROSS-REFERENCE TO RELATED APPLICATION

This application claims priority in U.S. Provisional Patent Application No. 63/414,763 Filed Oct. 10, 2022, which is incorporated herein by reference.

### BACKGROUND OF THE INVENTION

### 1. Field of the Invention

The present invention relates generally to a bucket cover and method for use and manufacture thereof, and more specifically to a reinforced, weatherproof truck bucket cover.

### 2. Description of the Related Art

Bucket covers for trucks are used to protect the interior of the buckets while not in use from rain and other weather. Traditionally they are made of 18 oz vinyl and are typically made as a two-piece set to be assembled. Often these covers sag under the weight of rain and snow, typically at the seam where stitches are placed. The seam allows water to seep through, rendering the cover less than satisfactory. The vinyl tends to only last a few months before it begins to crack along with the standard straps formed from polypropylene which tend to rot from the sun's ultraviolet (UV) rays.

What is needed is a cover that prevents deterioration in natural environments through superior materials and reinforced elements to prevent sagging.

Heretofore there has not been available a system or method for a bucket cover with the advantages and features of the present invention.

### BRIEF SUMMARY OF THE INVENTION

The present invention generally provides a bucket cover formed from one piece of 40 oz vinyl material with fiberglass supports. These supports are held in place using a strip of vinyl that is permanently bonded in place, thereby avoiding the need for stitches and preventing a weak spot for leaks to accumulate.

The fiberglass supports hold the cover up and away from the bucket, preventing sagging and eliminating water retention on the exterior of the cover. A gloss finish may be placed on the vinyl to improve resilience to sun and weather and to provide an easier surface to clean.

The straps of the present invention are made of polyester which tends to hold up against UV rays and moisture better than polypropylene straps.

Embodiments of the present invention can be constructed to fits buckets of all shapes and sizes.

### BRIEF DESCRIPTION OF THE DRAWINGS

The drawings constitute a part of this specification and include exemplary embodiments of the present invention illustrating various objects and features thereof.

FIG. 1 is a side elevational view of an embodiment of the present invention shown in a typical environment of a bucket truck bucket.

FIG. 2 is a detailed view taken about the circle of FIG. 1.

FIG. 3 is a top plan view of the embodiment thereof.

FIG. 4 is a side sectional view taken about the line of FIG. 3.

FIG. 5 is a top plan view of a second embodiment of the present invention.

FIG. 6 is a side sectional view taken about the line of FIG. 5.

FIG. 7 is a three-dimensional isometric view thereof.

FIG. 8 is a three-dimensional isometric view thereof shown in proximity with a typical environment of a bucket truck bucket.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Truck Bucket Cover System 2

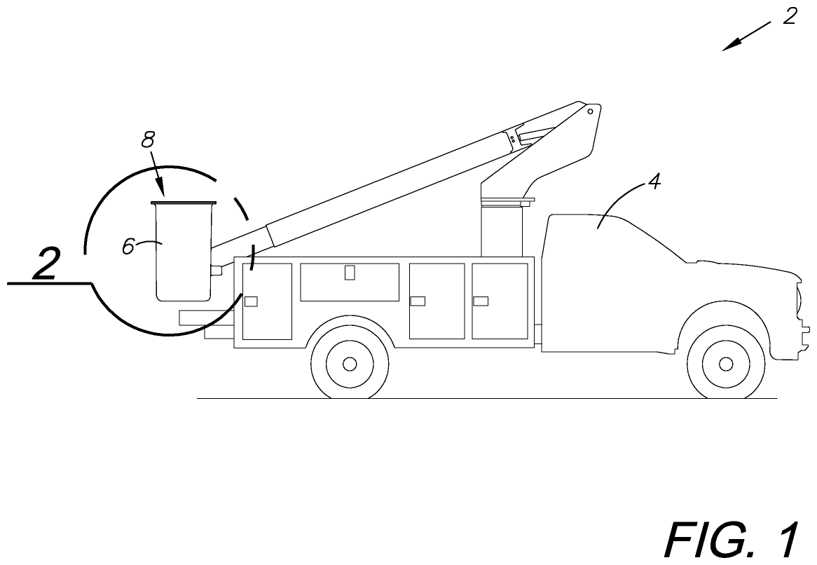

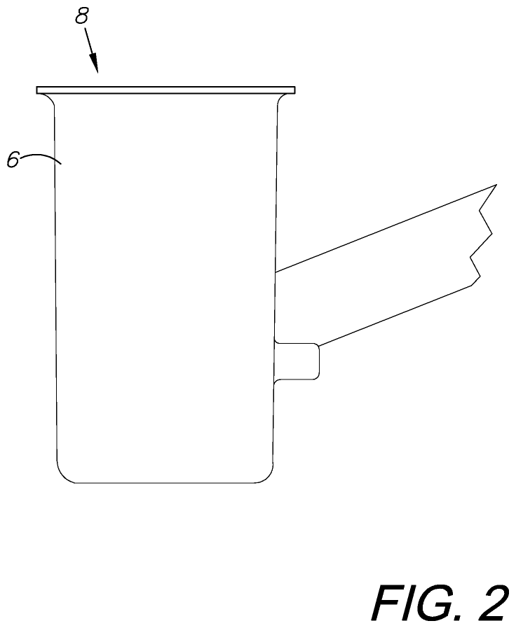

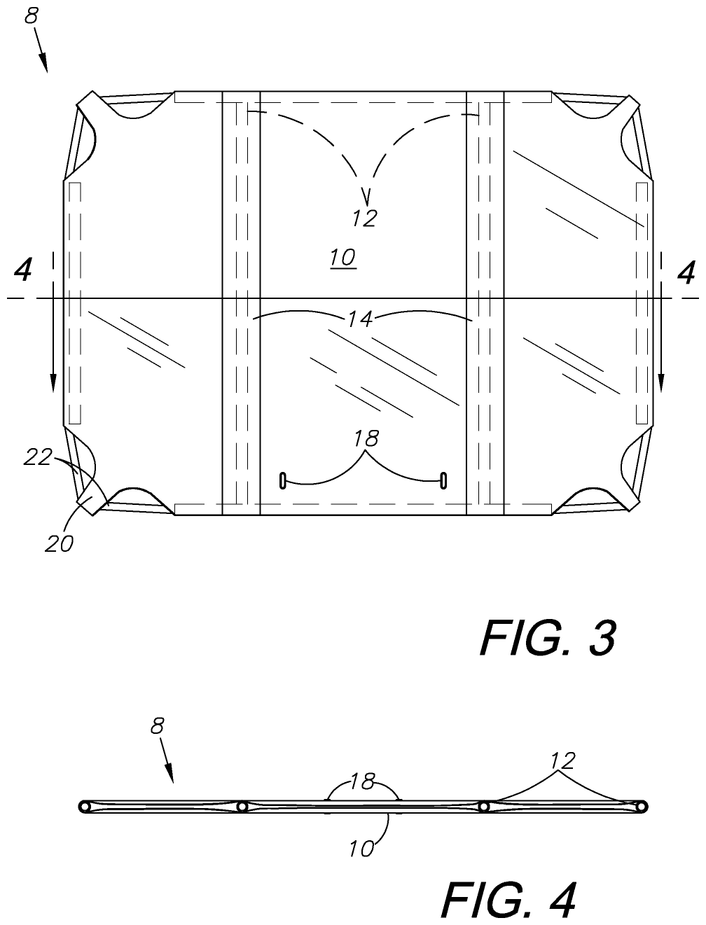

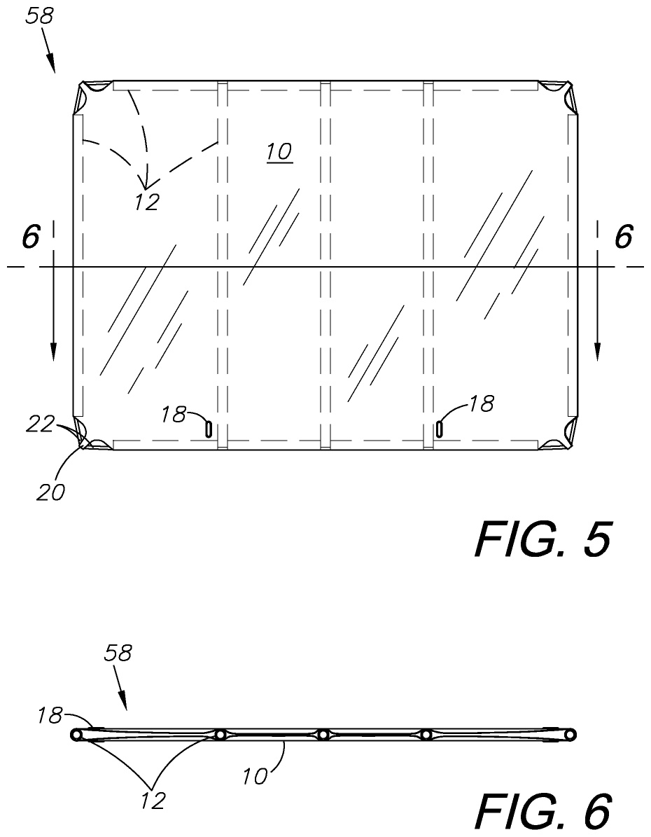

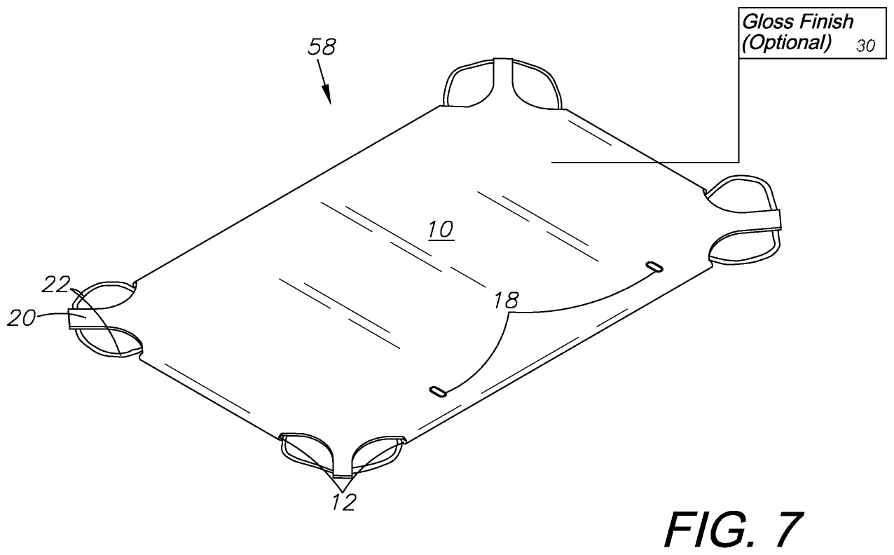

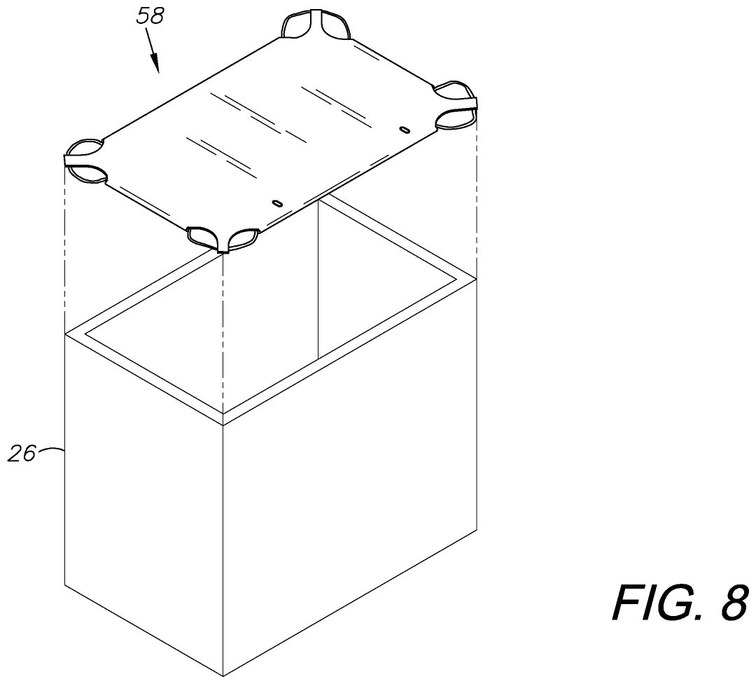

As shown in the figures, the present invention features truck bucket covers of various sizes to fit truck 4 buckets 6 of a one man, one-and-a-half, and two-man buckets. Larger buckets could also be fitted. FIGS. 1-4 show a first embodiment bucket cover 8, whereas FIGS. 5-8 show a second embodiment bucket cover 52.

The invention features a cover element 10 made of 40 oz Vinyl or other suitable materials. Fiberglass rods provide lightweight reinforcement within the cover 8, 58 to prevent sagging, thereby preventing water from building up and collapsing the cover or leading to leaks.

Any seams of the cover are secured by vinyl strips 14 adhered to the cover material 10, permanently bonded to the vinyl of the cover material. The same strips can be used to securely cover the fiberglass rods 12 and secure them into place. An optional gloss finish 30 can be applied to the vinyl material to further protect from water and to provide an easier-to-clean surface.

Securing straps 22 are made from polyester. These straps secure the cover 8, 58 to its respective bucket using corner tabs 20 of the cover material 10 along with grommets 18 located near the ends of the cover. The edges of the covers 8, 58 are designed to hang over the edge of the bucket such that the straps 12 can be tightened to fully secure the seal over the bucket.

Each cover can be rolled for easy storage or stacked for shipping. Colored threads could be used to help identify sizes for different bucket shapes. Similarly, binding materials such as the vinyl strips 14 could be color coded for the same purposes. The fiberglass rods 12 could be permanently affixed to the cover material 10 or may simply be inserted through receivers within the material.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A bucket cover system for a truck comprising a bucket lift, the system further comprising:
a waterproof cover comprising 40 oz vinyl;
a plurality of supports connected to said cover, thereby preventing buckling of said cover;
a respective plurality of vinyl strips configured to secure said respective plurality of supports by permanently bonding to said waterproof cover; and
at least one strap comprising polyester.

2. The system of claim 1, wherein said plurality of supports are comprised of fiberglass rods.

3. The system of claim 1, further comprising a gloss finish covering said waterproof cover, said gloss finished configured to enhance the cleanability of said waterproof cover.

4. The system of claim 1, further comprising a plurality of grommets affixed to said waterproof cover, said grommets configured to receive said at least one strap such that said at least one strap is configured to seal said waterproof cover to the bucket.
